(19) United States
(12) Patent Application Publication
(10) Pub. No.: US 2012/0303468 A1
(43) Pub. Date: Nov. 29, 2012

(54) INDIRECT ONLINE ADVERTISEMENTS PROMOTING THIRD-PARTY WEB CONTENT

(75) Inventor: ODED ELYADA, TEL AVIV (IL)

(73) Assignee: MICROSOFT CORPORATION, REDMOND, WA (US)

(21) Appl. No.: 13/113,485

(22) Filed: May 23, 2011

(51) Int. Cl. G06Q 30/00

(52) U.S. Cl. 705/14.73

(57) ABSTRACT

Systems, methods, and computer media for indirect advertising are provided. An identification of third-party web content related to an offering is received. The third-party web content is published by a third-party publisher, and the offering includes one or more of a product or service. Approval to configure at least one indirect online advertisement for the offering is received. The at least one indirect online advertisement includes a landing page that is presentable on a remote device. At least one indirect online advertisement is configured for presentation such that the third-party web content related to the offering and published by the third-party publisher is reachable via the landing page of the at least one configured indirect online advertisement.

### BACKGROUND

Online advertisements are ubiquitous on Internet web pages. Either display ads, shown along with web page content, or search ads, shown on search results pages, appear on most web pages. Conventionally, when a user clicks on an online advertisement, the user is navigated to a web page associated with the advertiser who placed the ad. Online advertisements, like conventional print, radio, or television advertisements, target a particular group of consumers. Online advertisements also typically target consumers at various stages in the purchase process. The purchase process is conventionally described as a “purchase funnel” in which the products or services being considered by the consumer are gradually narrowed from all available options to a single product or service that is ultimately purchased.

Stages in the purchase funnel vary by the definition used, but exemplary stages include, from broad to narrow: awareness, opinion, consideration, preference, and purchase. Advertising resources are limited, and to gain a greater benefit from resources invested, online advertisements are typically targeted at consumers in the later stages of the purchase funnel. For example, if a consumer has indicated she is looking for a particular model of camera, the consumer has likely already progressed through the first stages of the purchase funnel (is aware of camera options, has formed an opinion of which general types and/or brands meet the consumer's needs, and is ready to purchase or is considering purchasing a particular camera). Purchasing a search ad that will be placed on the consumer's search results page when the consumer enters a keyword search query for the particular camera model is an efficient use of resources in such a situation. Online advertisements directed to the early stages in the purchase funnel, however, are often an inefficient use of resources and are generally less favored.

### SUMMARY

Embodiments of the present invention relate to systems, methods, and computer media for indirect advertising. Using the systems and methods described herein, an identification of third-party web content related to an offering is received. The third-party web content is published by a third-party publisher. The offering includes one or more of a product or service. Approval to configure at least one indirect online advertisement for the offering is received. The at least one indirect online advertisement includes a landing page that is presentable on a remote device. At least one indirect online advertisement is configured for presentation such that the third-party web content related to the offering and published by the third-party publisher is reachable via the landing page of the at least one configured indirect online advertisement.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an indirect advertising system in accordance with embodiments of the present invention;

FIG. 3 is a flow chart of an exemplary method for indirect advertising in accordance with an embodiment of the present invention;

FIG. 4 is a flow chart of an exemplary method for indirect advertising in accordance with an embodiment of the present invention in which input is provided from both a publisher of related third-party web content and an advertiser; and

FIG. 5 is a flow chart of an exemplary method for indirect advertising in accordance with an embodiment of the present invention in which several steps are performed automatically.

### DETAILED DESCRIPTION

Embodiments of the present invention are described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” or “module” etc. might be used herein to connote different components of methods or systems employed, the terms should not be interpreted as implying any particular order among or between various steps herein disclosed unless and except when the order of individual steps is explicitly described.

Embodiments of the present invention relate to systems, methods, and computer media for indirect advertising. As discussed above, online advertisements are typically targeted at consumers in the later stages of the purchase process. Such advertisements conventionally offer greater return on the advertiser's investment. Online advertisements targeted to consumers in the early stages of the purchase process are less likely to result in a purchase and are relatively inefficient uses of resources.

In accordance with embodiments of the present invention, an online advertisement targeted at consumers in the early stages of the purchasing process is configured by leveraging third-party web content, such as product reviews, published by third parties not associated with the advertiser to increase the likelihood that the advertisement will result in a purchase. The online advertisement is indirect, because the landing page of the ad includes or links to the published third-party web content rather than to a web page associated with the advertiser. The advertiser promotes the third-party content as an indirect advertisement for the advertiser's offering, relying on the trust resulting from a relationship between the third-party publisher and the consumer to persuade the consumer to purchase the offering while the consumer is still in an early stage in the purchase process.

For example, a magazine not associated with an advertiser may positively review an advertiser's product. An advertisement, designed and/or paid for by the advertiser, is configured that promotes the magazine's review and that has a landing page publishing the magazine's review. Consumers who trust the magazine as an information source can be rapidly ushered along the purchase process by such a review.

In one embodiment of the present invention, an identification of third-party web content related to an offering is received. The third-party web content is published by a third-party publisher. The offering includes one or more of a product or service. Approval to configure at least one indirect online advertisement for the offering is received. The at least one indirect online advertisement includes a landing page that is presentable on a remote device. At least one indirect online advertisement is configured for presentation such that the third-party web content related to the offering and published by the third-party publisher is reachable via the landing page of the at least one configured indirect online advertisement.

In another embodiment, a content identification component identifies third-party web content related to an offering. The third-party web content is published by a third-party publisher. The offering includes one or more of a product or service. An approval component receives approval to configure at least one indirect online advertisement for the offering. The at least one indirect online advertisement includes a landing page that is presentable on a remote device. An advertisement configuration component configures at least one indirect online advertisement for presentation such that the third-party web content identified as related to the offering and published by the third-party publisher is reachable via the landing page of the at least one configured indirect online advertisement.

In still another embodiment, advertiser instructions for an offering are received. The offering includes one or more of a product or service. Third-party web content related to the offering is identified. The third-party web content is published by a third-party publisher. Based at least in part on the received advertiser instructions, configuration of at least one indirect online advertisement for the offering is automatically approved. The at least one indirect online advertisement includes a landing page that is presentable on a remote device. Also based at least in part on the received advertiser instructions, at least one indirect online advertisement is configured for presentation such that the third-party web content related to the offering and published by the third-party publisher is published on the landing page of the at least one configured indirect online advertisement.

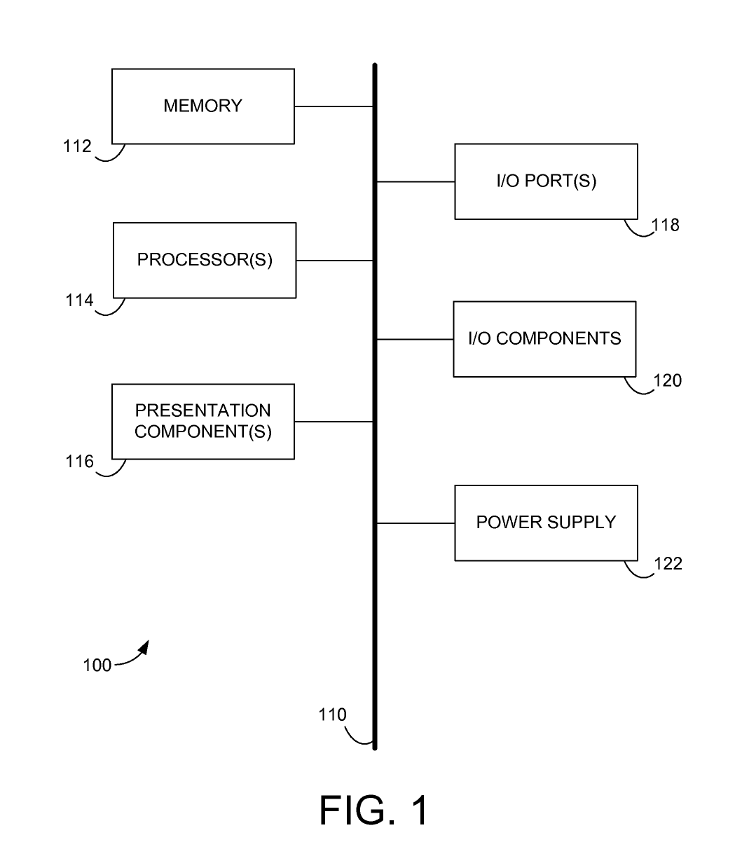

Having briefly described an overview of some embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of embodiments of the present invention. Neither should the computing device 100 be interpreted as having any dependency or requirement relating to any one or combination of components illustrated.

Embodiments of the present invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the present invention may be practiced in a variety of system configurations, including hand-held devices, consumer electronics, general-purpose computers, more specialty computing devices, etc. Embodiments of the present invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100.

Communication media typically embodies computer-readable instructions, data structures, program modules, or other data in a modulated data signal such as a carrier wave. The term “modulated data signal” refers to a propagated signal that has one or more of its characteristics set or changed to encode information in the signal. By way of example, and not limitation, communication media includes wired media, such as a wired network or direct-wired connection, and wireless media such as acoustic, RF, infrared, radio, microwave, spread-spectrum, and other wireless media. Combinations of the above are included within the scope of computer-readable media.

Memory 112 includes computer storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or 1/0 components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

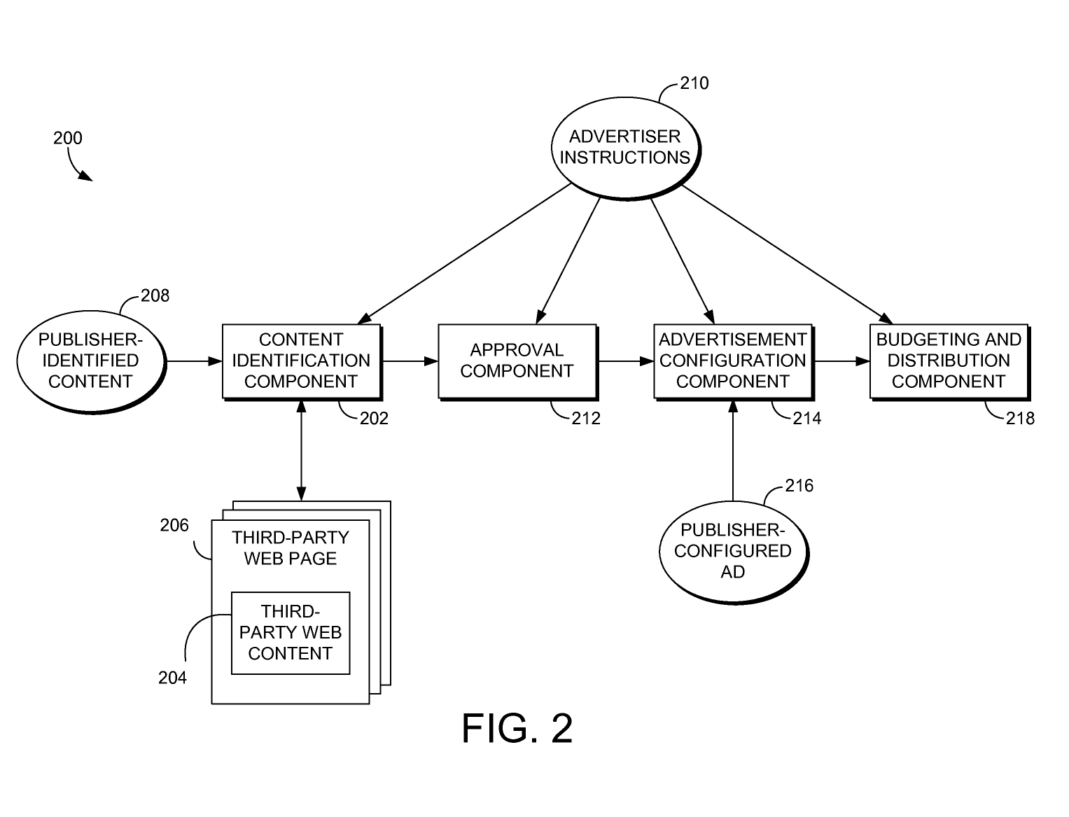

As discussed previously, embodiments of the present invention relate to systems, methods, and computer media for indirect advertising. Embodiments of the present invention will be discussed with reference to FIGS. 2-5.

FIG. 2 is a block diagram illustrating an exemplary indirect advertisement system 200. A content identification component 202 identifies third-party web content 204 related to an offering. Third-party web content 204 is published by a third-party publisher on a third-party web page 206. As used herein, “offering” is defined as something related to a product or service and includes, but is not limited to, a market, a sub-market, an industry, a business entity, a technology, a product, a product line, and a service.

Third-party web content 204 is related to the offering. For example, if the offering is a product, third-party web content 204 may include: a review of the product or product line; a review of a second product related to the first product; a discussion or review of the industry, company, or market of which the product is a part; a discussion or review of technology used by the product or a component of the product; and a critique of competitor products, product lines, or companies. Many other types of third-party web content are also envisioned.

In some embodiments, identified third-party web content 204 does not include information describing the offering. For example, an online article may describe the benefits of newly developed shatterproof glass and how smart phones incorporating this glass are leaps ahead of the competition. It may be well known that a company's smart phone incorporates the new shatterproof glass. The company can then create an indirect advertisement for the company's smart phone by promoting the third-party web content describing the shatterproof glass. Even though the third-party web content does not extol the virtues of the company's smart phone directly, convincing consumers that the new shatterproof glass is an essential feature will indirectly increase the likelihood of a consumer buying the company's smart phone.

In many cases, third-party web content 204 includes positive statements related to the offering, either positive statements about the offering directly or indirect positive statements, such as in the above smart phone example. In some embodiments, third-party web content 204 may include negative statements about an offering competitor or alternative technique or technology. As used herein, “third-party” web content means that the web content is not authored, provided, or published by the advertiser. Third-party web content is published by a third-party publisher. A “third-party publisher” is defined as an entity that is independent from the advertiser and is not an agent, affiliate, or subsidiary of the advertiser. A consumer is more likely to be influenced by third-party web content published by a third-party publisher because the content is not seen as being an advertisement placed by the advertiser but rather a more objective assessment of the offering.

In some embodiments, content identification component 202 identifies third-party web content 204 based on publisher-identified content 208. That is, in some cases, the third-party publisher who has published third-party web content 204 related to the offering notifies content identification component 202 of the presence of third-party web content 204. In this way, content identification component 202 receives notifications from various publishers about third-party web content for various offerings. In other embodiments, content identification component 202 identifies third-party web content 204 based on received advertiser instructions 210. Advertiser instructions 210 may specify: offerings for which third-party content is to be identified; third-party publishers trusted or preferred by the advertiser; a ranking of third-party publishers; third-party publishers that are not trusted or preferred; and other information.

Approval component 212 receives approval to configure at least one indirect online advertisement for the offering. The at least one indirect online advertisement includes a landing page that is presentable on a remote device. In some embodiments, approval component 212 automatically approves configuration of an indirect online advertisement based on advertiser instructions 210. Advertiser instructions 210 may specify various information related to approval, including: a number of indirect online advertisements that are to be created for specific types of third-party web content; trust or popularity thresholds for the identified third-party web content that are exceeded before an indirect online advertisement is configured; and other information.

In some embodiments, content identification component 202 only identifies content for which configuration of an indirect advertisement is approved, effectively combining the functionality of content identification component 202 and approval component 212. In other embodiments, approval component 212 receives approval from the advertiser for each instance of identified third-party web content. In such embodiments, each instance of identified third-party web content may be provided to the advertiser for approval, and the advertiser approves or does not approve each identified instance.

Advertisement configuration component 214 configures at least one indirect online advertisement for presentation such that third-party web content 204 identified as related to the offering and published by the third-party publisher is reachable via the landing page of the at least one configured indirect online advertisement. In some embodiments, advertisement configuration component 214 configures the indirect online advertisement according to advertiser instructions 210, which may specify: an advertisement style (such as text only, pop-up, etc); a preferred advertisement creative type; or other information. Third-party web content 204, which is related to the offering and published by a third-party publisher, may be published on the landing page of the at least one indirect online advertisement configured by advertisement configuration component 214. That is, the landing page of the configured indirect online advertisement may be third-party web page 206. In other embodiments, the landing page of the configured indirect online advertisement is a web page through which third-party web content 204 is reachable (for example by clicking on a hyperlink found on the landing page).

In some embodiments, the third-party publisher of third-party web content 204 provides a publisher-configured indirect online advertisement 216 to advertisement configuration component 214. Publisher-configured indirect online advertisement 216 may be reviewed by the advertiser prior to distribution.

Budgeting and distribution component 218 determines the number of instances of a configured indirect online advertisement that are published on particular sites. Advertiser instructions 210 may specify a budget and/or distribution instructions for configured indirect advertisements. In other embodiments, the advertiser may provide budgeting and distribution instructions after reviewing the configured indirect online advertisement. Determination of online advertisement budgeting, priority, keyword or target user purchasing, and other aspects of conventional online advertising systems are beyond the scope of this application.

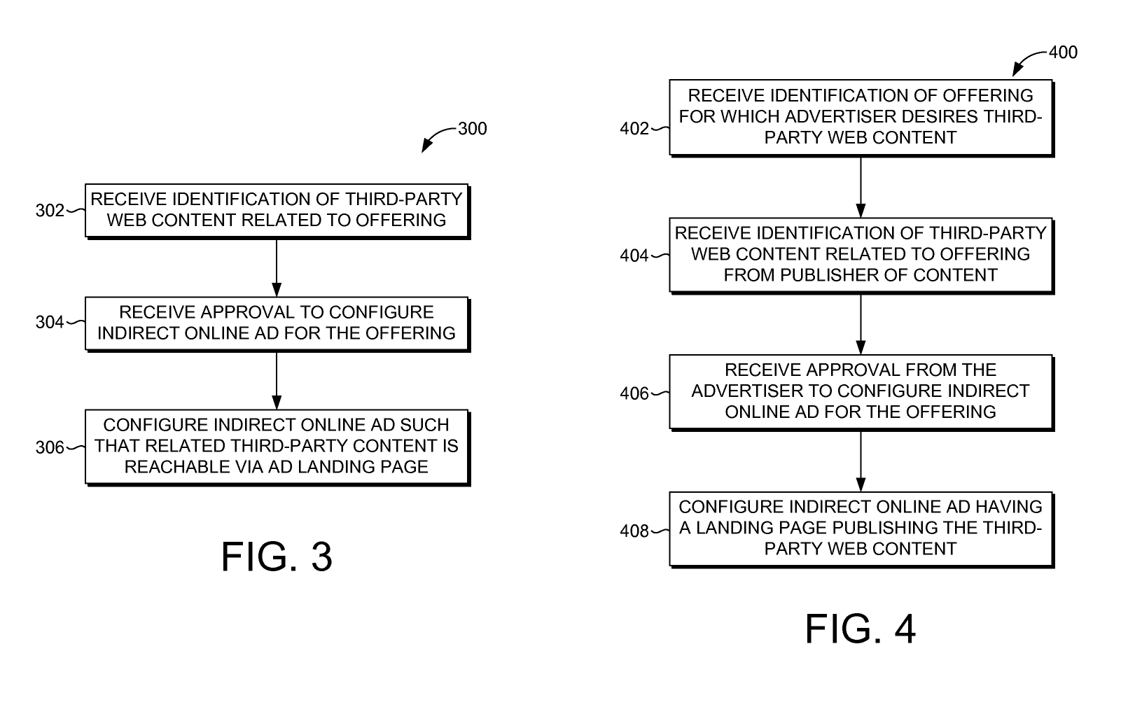

Content identification component 202, approval component 212, advertisement configuration component 214, and budgeting and distribution component 218 are contemplated as both automatically executing various tasks and performing tasks based on advertiser input. FIG. 3 illustrates an exemplary method 300 for indirect advertising. In step 302, identification of third-party web content related to an offering is received. In step 304, approval to configure an indirect online advertisement for the offering is received. At least one indirect online advertisement is configured in step 306 such that the related third-party web content is reachable via the indirect online advertisement's landing page.

In one embodiment, the related third-party web content identified in step 302 is published by a third-party publisher on the landing page of the at least one indirect online advertisement. In other embodiments, the indirect online advertisement configured in step 306 is an advertisement containing primarily text related to a title or snippet of the third-party web content. For example, the indirect online advertisement may be a hyperlinked text title or summary of the content.

In some embodiments, a first advertiser provides the offering or is an affiliate or agent of a party who provides the offering, and the identified third-party web content is provided to the first advertiser for approval prior to performing step 306 and configuring the at least one indirect online advertisement. In other embodiments, the at least one indirect online advertisement is configured according to advertiser instructions provided by the first advertiser. In still other embodiments, approval to configure at least one indirect online advertisement for the offering is not received unless advertiser instructions to consider identified third-party web content for the offering were previously received. In some embodiments, configuration step 306 is automatically performed upon receiving approval to configure the at least one indirect online advertisement in step 304.

FIG. 4 is a flow chart of an exemplary method 400 for indirect advertising in which input is provided from both a publisher of related third-party web content and an advertiser. In step 402, an identification of an offering for which an advertiser desires third-party web content is received. An identification of third-party web content related to the offering is then received from the publisher of the content in step 404. In step 406, approval to configure an indirect online advertisement for the offering is received from the advertiser. In step 408, an indirect online advertisement is configured. The landing page of the advertisement may publish the third-party web content. The online advertisement may be configured based on advertiser or publisher instructions, including advertiser specification of the creative, layout, size, and other characteristics of the advertisement, or the advertisement may be configured automatically.

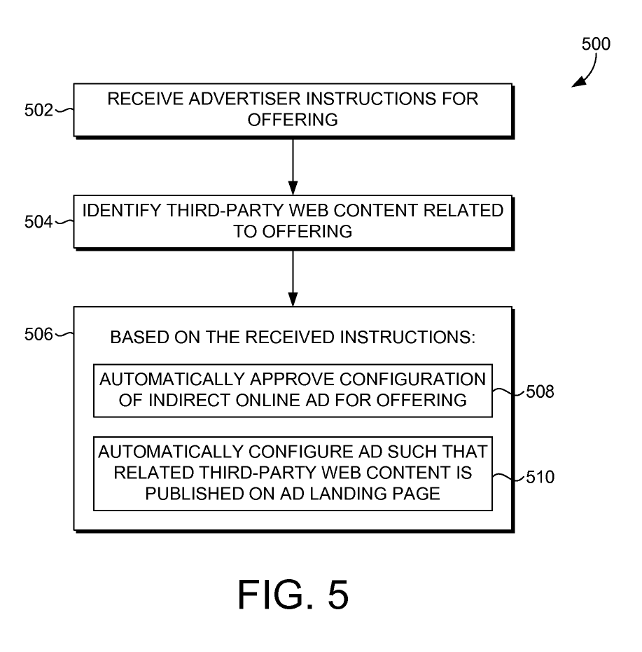

FIG. 5 is a flow chart of an exemplary method 500 for indirect advertising in accordance with an embodiment of the present invention in which several steps are performed automatically. In step 502, advertiser instructions for an offering are received. The advertiser instructions may include but are not limited to: identification of the offering for which third-party content is to be identified; third-party publishers trusted or preferred by the advertiser; a ranking of third-party publishers; third-party publishers that are not trusted or preferred; advertisement style (such as text only, pop-up, etc); a preferred advertisement creative type; a number of indirect online advertisements that are to be created for specific types of third-party web content; trust or popularity thresholds for the identified third-party web content that must be exceeded for configuration of an indirect online advertisement; or any other information useful in performing method 500.

In step 504, third-party web content related to the offering is identified. The identification may be made based on the instructions received in step 502. In step 506, automatic steps 508 and 510 are carried out based on the instructions received in step 502. In step 508, configuration of an indirect online advertisement for the offering is automatically approved. In step 510, the indirect online advertisement is automatically configured such that the identified related third-party web content is published on the landing page of the indirect online advertisement.

Method 300 of FIG. 3, method 400 of FIG. 4, and method 500 of FIG. 5 may be implemented by content identification component 202, approval component 212, advertisement configuration component 214 of FIG. 2.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

Having thus described the invention, what is claimed is:

1. Computer-readable media having embodied thereon computer-executable instructions that, when executed by a computing device, perform a method for indirect advertising, the method comprising:
receiving an identification of third-party web content related to an offering,
wherein the third-party web content is published by a third-party publisher, and
wherein the offering includes one or more of a product or service;
receiving approval to configure at least one indirect online advertisement for the offering, the at least one indirect online advertisement including a landing page that is presentable on a remote device; and
configuring at least one indirect online advertisement for presentation such that the third-party web content related to the offering and published by the third-party publisher is reachable via the landing page of the at least one configured indirect online advertisement.

2. The computer-readable media of claim 1, wherein the third-party web content related to the offering and published by the third-party publisher is published on the landing page of the at least one configured indirect online advertisement, and wherein upon receiving a user selection of the at least one configured indirect online advertisement, the third-party web content is presented.

3. The computer-readable media of claim 1, wherein the third-party web content related to the offering is a review that includes positive statements related to the offering.

4. The computer-readable media of claim 3, wherein the offering is a first product, and wherein the third-party web content related to the offering is at least one of a review of the first product or a review of a second product related to the first product.

5. The computer-readable media of claim 1, wherein the at least one configured indirect online advertisement is configured such that the indirect online advertisement is presented as an advertisement containing primarily text, wherein the text is related to a title or snippet of the third-party web content.

6. The computer-readable media of claim 1, wherein the at least one configured indirect online advertisement does not include information describing the offering.

7. The computer-readable media of claim 1, wherein the identification of the third-party web content related to the offering is made by the publisher who published the third-party web content.

8. The computer-readable media of claim 1, wherein a first advertiser provides the offering or is an affiliate or agent of a party who provides the offering, and further comprising providing the identified third-party web content to the first advertiser for approval prior to configuring the at least one indirect online advertisement.

9. The computer-readable media of claim 1, wherein a first advertiser provides the offering or is an affiliate or agent of a party who provides the offering, and wherein the at least one indirect online advertisement is configured according to advertiser instructions provided by the first advertiser.

10. The computer-readable media of claim 1, wherein approval to configure at least one indirect online advertisement for the offering is not received unless advertiser instructions to consider identified third-party web content for the offering were previously received.

11. The computer-readable media of claim 1, wherein the at least one indirect online advertisement is automatically configured upon receiving approval to configure the at least one indirect online advertisement.

12. Computer-readable media having a system embodied thereon including computer-executable instructions that, when executed, perform a method for indirect advertising, the system comprising:
a content identification component that identifies third-party web content related to an offering,
wherein the third-party web content is published by a third-party publisher, and
wherein the offering includes one or more of a product or service;
an approval component that receives approval to configure at least one indirect online advertisement for the offering, the at least one indirect online advertisement including a landing page that is presentable on a remote device; and
an advertisement configuration component that configures at least one indirect online advertisement for presentation such that the third-party web content identified as related to the offering and published by the third-party publisher is reachable via the landing page of the at least one configured indirect online advertisement.

13. The computer-readable media of claim 12, wherein the third-party web content related to the offering and published by the third-party publisher is published on the landing page of the at least one indirect online advertisement configured by the advertisement configuration component.

14. The computer-readable media of claim 12, wherein the third-party web content related to the offering is a review that includes positive statements related to the offering.

15. The computer-readable media of claim 12, wherein the at least one configured indirect online advertisement does not include information describing the offering.

16. The computer-readable media of claim 12, wherein based at least in part on received advertiser instructions:
the content identification component automatically identifies the third-party web content related to the offering;
the approval component automatically approves configuration of the at least one indirect online advertisement for the offering; and
the advertisement configuration component automatically configures the at least one indirect online advertisement.

17. Computer-readable media having embodied thereon computer-executable instructions that, when executed by a computing device, perform a method for indirect advertising, the method comprising:
receiving advertiser instructions for an offering, wherein the offering includes one or more of a product or service;
identifying third-party web content related to the offering, wherein the third-party web content is published by a third-party publisher; and
based at least in part on the received advertiser instructions:
automatically approving configuration of at least one indirect online advertisement for the offering, the at least one indirect online advertisement including a landing page that is presentable on a remote device, and
automatically configuring at least one indirect online advertisement for presentation such that the third-party web content related to the offering and published by the third-party publisher is published on the landing page of the at least one configured indirect online advertisement.

18. The computer-readable media of claim 17, wherein the offering is a first product, and wherein the third-party web content related to the offering is at least one of a review of the first product or a review of a second product related to the first product.

19. The computer-readable media of claim 17, wherein the at least one configured indirect online advertisement is configured such that the indirect online advertisement is presented as an advertisement containing primarily text, wherein the text is related to a title or snippet of the third-party web content.

20. The computer-readable media of claim 17, wherein the at least one configured indirect online advertisement does not include information describing the offering.
